(19) United States
(12) Patent Application Publication
(10) Pub. No.: US 2005/0039134 A1
(43) Pub. Date: Feb. 17, 2005

(54) System and method for effectively implementing a dynamic user interface in an electronic network

(75) Inventors: Elke Wiggeshoff, San Jose, CA (US); David Gaxiola, San Jose, CA (US)

Correspondence Address: Gregory J. Koerner;Redwood Patent Law, 1291 East Hillsdale Boulevard, Suite 205, Foster City, CA, 94404, US

(73) Assignees: Sony Corporation; Sony Electronics Inc.

(21) Appl. No.: 10/638,843

(22) Filed: Aug. 11, 2003

(51) Int. Cl. G09G 5/00

(52) U.S. Cl. 715/752; 715/777; 715/739; 715/758; 715/753; 715/751; 715/762

(57) ABSTRACT

A system and method for effectively implementing a dynamic user interface in an electronic network may include a user interface application that is configured to generate a user interface upon a display of a user device in the electronic network. The user interface application may generate a main widget for controlling and utilizing various types of system functionality through the user interface. The user interface application may further dynamically generate a connect widget for performing network communications procedures between the user device and one or more buddy devices in the electronic network. The user interface application may also dynamically generate an alert widget for providing various types of system alert messages to a device user.

### BACKGROUND SECTION

1. Field of the Invention

This invention relates generally to techniques for displaying information in an electronic device, and relates more particularly to a system and method for effectively implementing a dynamic user interface in an electronic network.

2. Description of the Background Art

Implementing effective methods for displaying information in an electronic device is a significant consideration for designers and manufacturers of contemporary electronic devices. However, effectively displaying information utilized by electronic devices may create substantial challenges for system designers. For example, enhanced demands for increased device functionality and performance may require more system processing power and require additional software resources. An increase in processing or software requirements may also result in a corresponding detrimental economic impact due to increased production costs and operational inefficiencies.

Furthermore, enhanced device capability to perform various advanced network operations may provide additional benefits to a system user, but may also place increased demands on the control and management of various user interface mechanisms. For example, an enhanced electronic network device that effectively handles and displays digital image data may frequently benefit from an efficient implementation because of the large amount and complexity of the digital data involved.

Due to growing demands on system resources and substantially increasing data magnitudes, it is apparent that developing new techniques for displaying information in an electronic network device is a matter of concern for related electronic technologies. Therefore, for all the foregoing reasons, developing effective systems for displaying information in an electronic network device remains a significant consideration for designers, manufacturers, and users of contemporary electronic systems.

### SUMMARY

In accordance with the present invention, a system and method for effectively implementing a dynamic user interface in an electronic network are disclosed. In one embodiment, a user device in the electronic network may launch a user interface application to provide a dynamic user interface on a display of the user device. A device user may then effectively utilize the dynamic user interface to perform various network communications procedures between the user device and one or more buddy devices in the electronic network.

In certain embodiments, the user interface application may initially generate and display a main widget on the display of the user device. The main widget may include, but is not limited to, a presence tab, a MEET tab, a buddy tab, a content tab, an info tab, and a main window area for selecting and displaying various types of network communications functionality and other related information.

The device user may utilize the main widget to initiate any desired off-line functions in an off-line mode. For example, in a content off-line mode, the content tab may be selected for adding shareable content information, for editing shareable content information, or for removing shareable content information for potentially sharing with various buddy devices over the electronic network.

The device user may also utilize the main widget to initiate various on-line functions in an on-line mode. For example, in certain embodiments, the device user may select the presence tab for changing various presence attributes of the user device. The device user may also select the buddy tab to add a new buddy device from the electronic network to a buddy list, to remove a current buddy device from the buddy list, or to edit various types of buddy information for one or more of the buddy devices.

Furthermore, in the on-line mode, the device user may select the content tab for viewing a list of previously-defined shareable content information. The device user may then send one or more content sharing invitations to corresponding buddy devices in the electronic network for potentially sharing the designated shareable content information. In addition, the device user may select the info tab to create and transmit a request for profile information regarding any of the device users of the buddy devices in the electronic network.

In the on-line mode, the device user may also select the MEET tab to generate a MEET widget for displaying one or more buddy entries that each correspond to one of the buddy devices in the electronic network. Each of the buddy entries may include various types of buddy information corresponding to that respective buddy entry. The device user may utilize the user interface application to selectively generate a communications menu corresponding to any of the buddy entries in the MEET widget.

A device user may utilize the foregoing communications menu to initiate network communications procedures over the electronic network. For example, the device user may utilize the communications menu to designate a particular buddy device with which to selectively enter either an instant messaging mode, a single message mode, or a content messaging mode. The user interface application may then dynamically generate a content widget for performing the selected network communications procedure.

In certain embodiments, the user interface application may also advantageously display a dynamic alert widget at any time for viewing one or more corresponding alert messages by the device user. The present invention therefore provides an improved dynamic user-interface for conducting network communications procedures in an electronic network by dynamically organizing and displaying appropriate information in an effective manner.

### BRIEF DESCRIPTION OF THE DRAWINGS

FIG. 1 is a block diagram of an electronic network, in accordance with one embodiment of the present invention;

FIG. 2 is a block diagram for one embodiment of the user device of FIG. 1, in accordance with the present invention;

FIG. 3 is a block diagram for one embodiment of the memory of the FIG. 2 user device, in accordance with the present invention;

FIG. 4 is a diagram for one embodiment of a main widget for performing a network communications procedure, in accordance with the present invention;

FIG. 5 is a diagram for one embodiment of a MEET widget for a performing network communications procedure, in accordance with the present invention;

FIG. 6 is a diagram for one embodiment of a connect widget for performing a network communications procedure, in accordance with the present invention;

FIG. 7 is a diagram for one embodiment of an alert widget, in accordance with the present invention; and

FIG. 8 is a flowchart of method steps for utilizing a dynamic user interface, in accordance with one embodiment of the present invention.

### DETAILED DESCRIPTION

The present invention relates to an improvement in electronic information display techniques. The following description is presented to enable one of ordinary skill in the art to make and use the invention, and is provided in the context of a patent application and its requirements. Various modifications to the disclosed embodiments will be readily apparent to those skilled in the art, and the generic principles herein may be applied to other embodiments. Thus, the present invention is not intended to be limited to the embodiments shown, but is to be accorded the widest scope consistent with the principles and features described herein.

The present invention comprises a system and method for effectively implementing a dynamic user interface in an electronic network, and may include a user interface application that is configured to generate a user interface upon a display of a user device in the electronic network. The user interface application may advantageously generate a main widget for controlling and utilizing various types of system functionality through the user interface. The user interface application may further dynamically generate a connect widget for performing network communications procedures between the user device and one or more buddy devices in the electronic network, and may also dynamically generate an alert widget for providing various types of system alert messages to a device user.

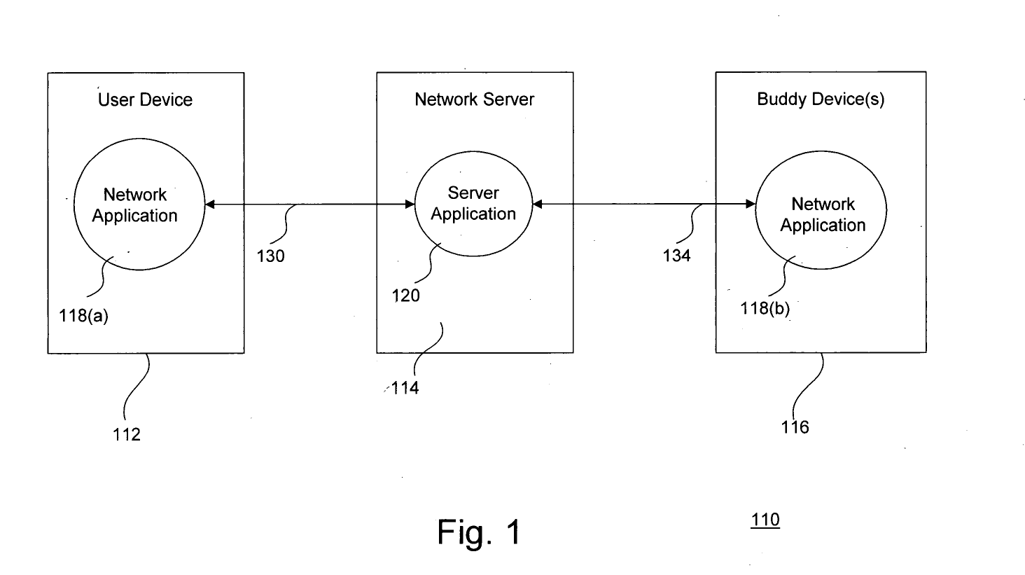

Referring now to FIG. 1, a block diagram of an electronic network 110 is shown, in accordance with one embodiment of the present invention. In the FIG. 1 embodiment, electronic network 110 may preferably include, but is not limited to, a user device 112, a network server 114, and one or more buddy device(s) 116. In alternate embodiments, electronic network 110 may readily be implemented using various components and configurations in addition to, or instead of, those discussed in conjunction with the FIG. 1 embodiment.

In the FIG. 1 embodiment, user device 112 and buddy device(s) 116 may be implemented as any type of appropriate electronic devices. For example, in certain embodiments, user device 112 and buddy device(s) 116 may be implemented as stationary or portable computer devices. In the FIG. 1 embodiment, user device 112 and buddy device(s) 116 may utilize respective network applications 118(a) and 118(b) to communication through network server 114 via server application 120. For example, user device 112 may communicate with one or more buddy device(s) 116 by utilizing instant messaging techniques that support bi-directional messaging across electronic network 110 via network server 114.

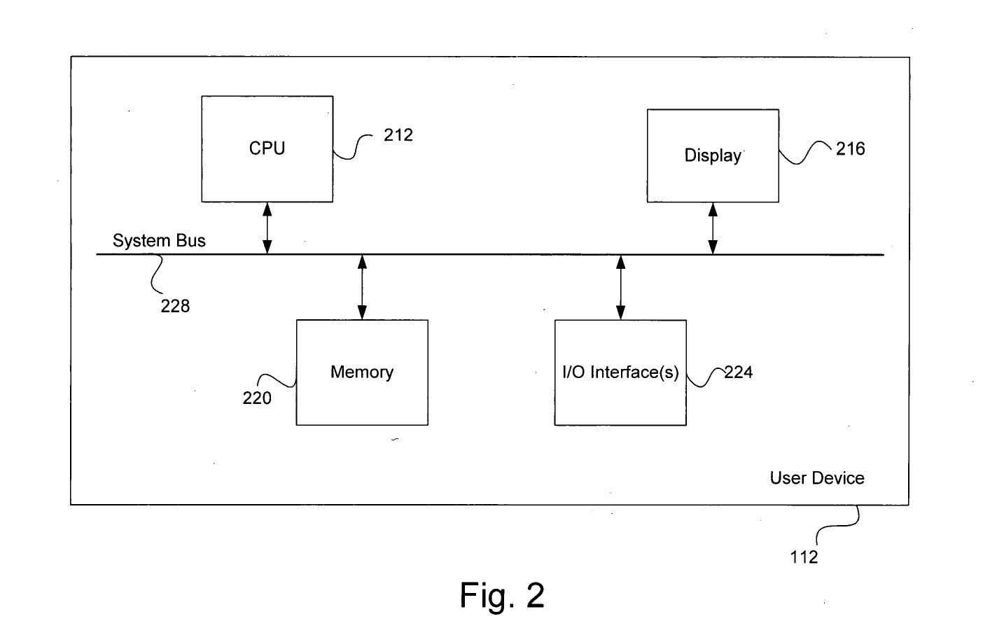

In addition, user device 112 may initiate a network service sharing procedure by transmitting a service invitation to selected buddy device(s) 116 on electronic network 110 for sharing one or more network services. For example, in certain embodiments, user device 112 may store specified image data for a particular network service on a designated memory resource. User device 112 may then broadcast a network service invitation to one or more buddy device(s) 116 through network server 114 for accessing and utilizing the stored image data. The implementation and utilization of user device 112 is further discussed below in conjunction with FIG. 2 through FIG. 8.

Referring now to FIG. 2, a block diagram for one embodiment of the FIG. 1 user device 112, is shown, in accordance with the present invention. In the FIG. 2 embodiment, user device 112 preferably may include, but is not limited to, a central processing unit (CPU) 212, a display 216, a memory 220, and one or more input/output interface(s) (I/O interface(s)) 224. The foregoing components of user device 112 may preferably be coupled to, and communicate through, a system bus 228. In alternate embodiments, user device 112 may readily be implemented using various components and configurations in addition to, or instead of, those discussed in conjunction with the FIG. 2 embodiment.

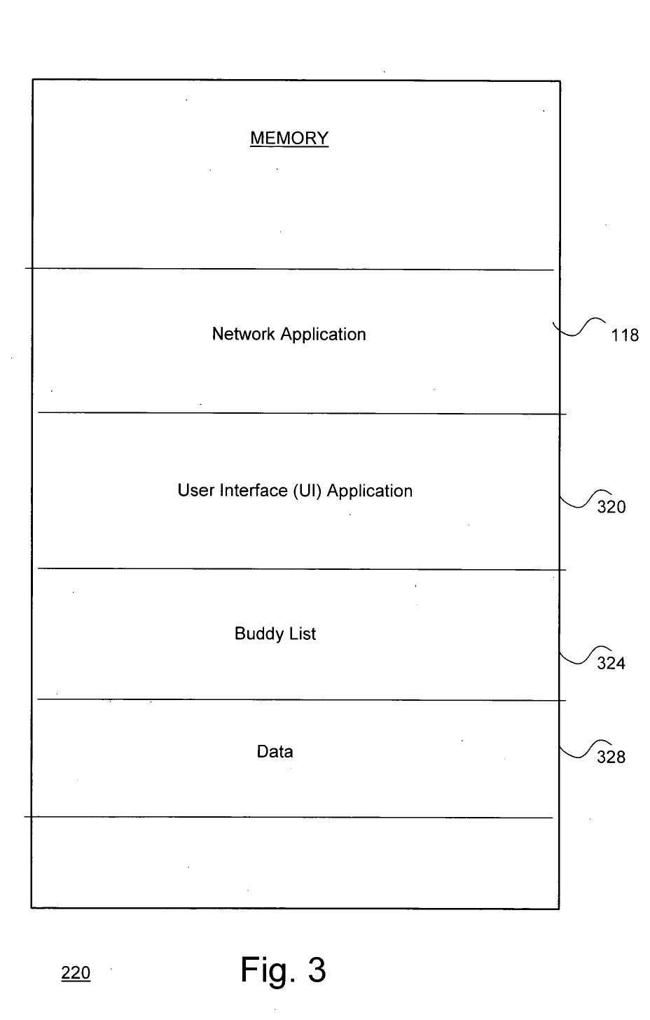

In the FIG. 2 embodiment, CPU 212 may be implemented to include any appropriate and compatible microprocessor device that preferably executes software instructions to thereby control and manage the operation of user device 112. The FIG. 2 display 216 preferably may include any effective type of display technology including a cathode-ray-tube monitor or a liquid-crystal display device with an appropriate screen for displaying various information to a device user. In the FIG. 2 embodiment, memory 220 may be implemented to include any combination of desired storage devices, including, but not limited to, read-only memory (ROM), random-access memory (RAM), and various types of non-volatile memory, such as floppy disks or hard disks. The contents and functionality of memory 220 are further discussed below in conjunction with FIG. 3.

In the FIG. 2 embodiment, I/O interface(s) 224 may preferably include one or more input and/or output interfaces to receive and/or transmit any required types of information by user device 112. I/O interface(s) 224 may include one or more means for allowing a device user to communicate with user device 112. For example, the foregoing means may include a keyboard device, a wireless remote control device, a speech-recognition module with corresponding microphone, a graphical user interface with touch-screen capability, or a selection button array mounted externally on user device 112.

The foregoing FIG. 2 embodiment is discussed above in the context of an implementation of user device 112. However, in certain embodiments of electronic network 110, various buddy device(s) 116 may be also be implemented in a manner that is the same or similar to the configuration and functionalities discussed above in conjunction with the FIG. 2 embodiment of user device 112.

Referring now to FIG. 3, a block diagram for one embodiment of the FIG. 2 memory 220 is shown, in accordance with the present invention. In the FIG. 3 embodiment, memory 220 preferably includes, but is not limited to, a network application 118, a user interface (UI) application 320, a buddy list 324, and data 328. In alternate embodiments, memory 220 may readily include various other components in addition to, or instead of, those components discussed in conjunction with the FIG. 3 embodiment.

In the FIG. 3 embodiment, network application 118 may include program instructions that are preferably executed by CPU 212 (FIG. 2) to perform various functions and operations for user device 112. The particular nature and functionality of network application 118 preferably varies depending upon factors such as the specific type and particular functionality of the corresponding user device 112. For example, in certain embodiments, network application 118 may include appropriate middleware for communicating with server application 120 of network server 114 (FIG. 1).

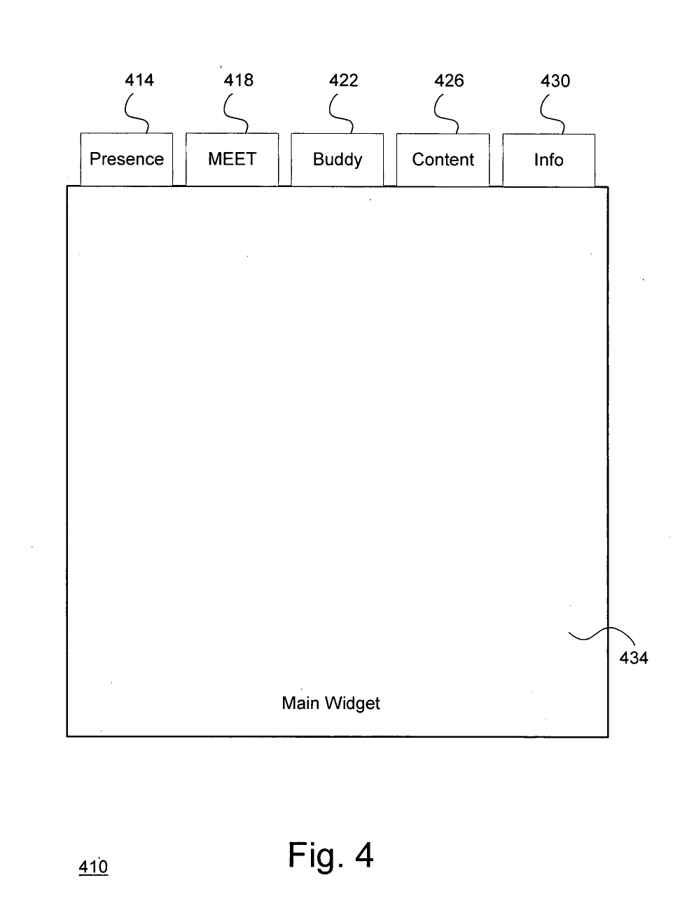

In the FIG. 3 embodiment, user device 112 may advantageously utilize UI application 320 to generate and present an appropriate and effective user interface upon the screen of display 216 (FIG. 2) for the device user to perform various functions with user device 112. Several embodiments and corresponding functionalities for the foregoing user interface provided by UI application 320 are further discussed below in conjunction with FIG. 4 through FIG. 7.

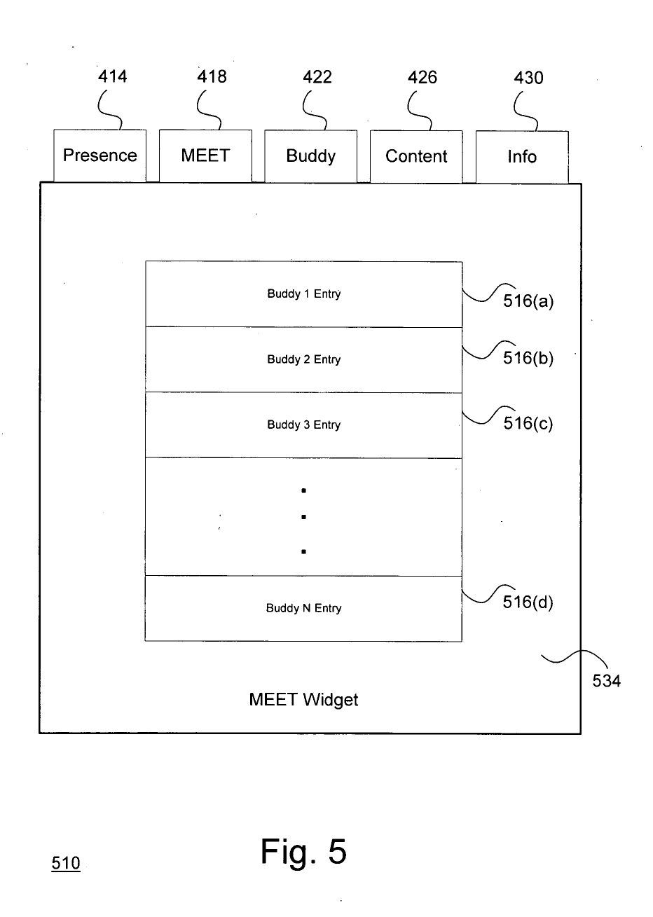

In the FIG. 3 embodiment, buddy list 324 may include an editable listing of selected buddy devices 116 (FIG. 1) that have been specifically designated as communication partners for user device 112. Buddy list 324 is further discussed below in conjunction with FIGS. 4 and 5. In the FIG. 3 embodiment, data 328 may include any appropriate information for use by user device 112. For example, data 328 may include, but is not limited to, various types of network service data for sharing with designated buddy devices 116 in a network service sharing procedure, locally-stored user preferences for use by network application 118, and a dynamically updateable data model that flexibly caches various status changes to UI application 320 (FIG. 3). In certain embodiments, the foregoing network service data may include, but is not limited to, shareable content information like image data, graphics data, audio data, or text data.

The foregoing FIG. 3 embodiment is discussed above in the context of an implementation of memory 220 for user device 112. However, in certain embodiments of electronic network 110, memory devices of various buddy device(s) 116 may be also be implemented in a manner that is the same or similar to the configuration and functionalities discussed above in conjunction with the FIG. 2 embodiment. More specifically, various buddy device(s) 116 may include and utilize corresponding UI applications 320 that are implemented in the same or similar manner as the UI application 320 discussed above in conjunction with the FIG. 3 embodiment.

Referring now to FIG. 4, a diagram for one embodiment of a main widget 410 for a network communications procedure is shown, in accordance with the present invention. In the FIG. 4 embodiment, main widget 410 may include, but is not limited to, a presence tab 414, a MEET tab 418, a buddy tab 422, a content tab 426, an info tab 430, and a main window area 434. In alternate embodiments, main widget 410 may readily include various other elements and functionalities in addition to, or instead of, those elements and functionalities discussed in conjunction with the FIG. 4 embodiment.

In the FIG. 4 embodiment, UI application 320 may display main widget 434 upon a portion of the screen of display 216 (FIG. 2) for use by a device user. For example, in certain embodiments, main widget 434 may be displayed in the upper left quadrant of the screen of display 216. UI application 320 may then display various types of relevant information and widgets in the main window area 434, depending upon which of the tabs 414 through 430 are selected by the device user.

In certain embodiments, a currently selected tab may be indicated to the device user in any effective manner. For example, a currently selected tab may be highlighted in comparison to the other non-selected tabs. In addition, certain tabs may be disabled or enabled, depending upon the current state of user device 112. For example, in certain embodiments, in an off-line mode in which user device is not logged-in to network server 114, only presence tab 414 and content 426 may be enabled because the functionalities of the other tabs are not currently available to the device user.

In the FIG. 4 embodiment, presence tab 414 may be selected to enter either a presence on-line mode or a presence off-line mode which may each provide different user-interface information in main window area 434. In the presence off-line mode, presence tab 414 may be utilized for logging-in to network server 114 for gaining access to electronic network 110. In the presence on-line mode, presence tab 414 may be utilized for logging-out from network server 114, or for changing various presence attributes of user device 112. For example, a visibility attribute for user device 112 may be selected as either “visible” or “invisible” with respect to the other entities in electronic network 110. In addition, a status attribute for user device 112 may be selected to indicate “normal”, “chat”, “do not disturb”, “extended away”, or “away” status for user device 112.

In the FIG. 4 embodiment, MEET tab 418 may be selected to provide a MEET widget for performing various network communications procedures between user device 112 and one or more buddy device(s) 116. The MEET widget may display buddy entries from buddy list 324 (FIG. 3) along with corresponding buddy information and shareable content information. The MEET widget is further discussed below in conjunction with FIG. 5. In the FIG. 4 embodiment, buddy tab 422 may be selected to add a new buddy device 116 to buddy list 324, to remove a current buddy device 116 from buddy list 324, or to edit various types of buddy information such as the buddy group or buddy name for one or more of the buddy devices 116.

In the FIG. 4 embodiment, content tab 426 may be selected to enter either a content off-line mode or a content on-line mode which may each provide different user-interface information in main window area 434. In the content off-line mode, content tab 426 may be selected for adding shareable content information, for editing shareable content information, or for removing shareable content information for potentially sharing with various buddy devices 116 over electronic network 110. In the content on-line mode, content tab 426 may be selected for viewing a list of previously-defined, shareable content information. The device user may then send one or more content sharing invitations to corresponding buddy devices 116 for potentially sharing the designated shareable content information.

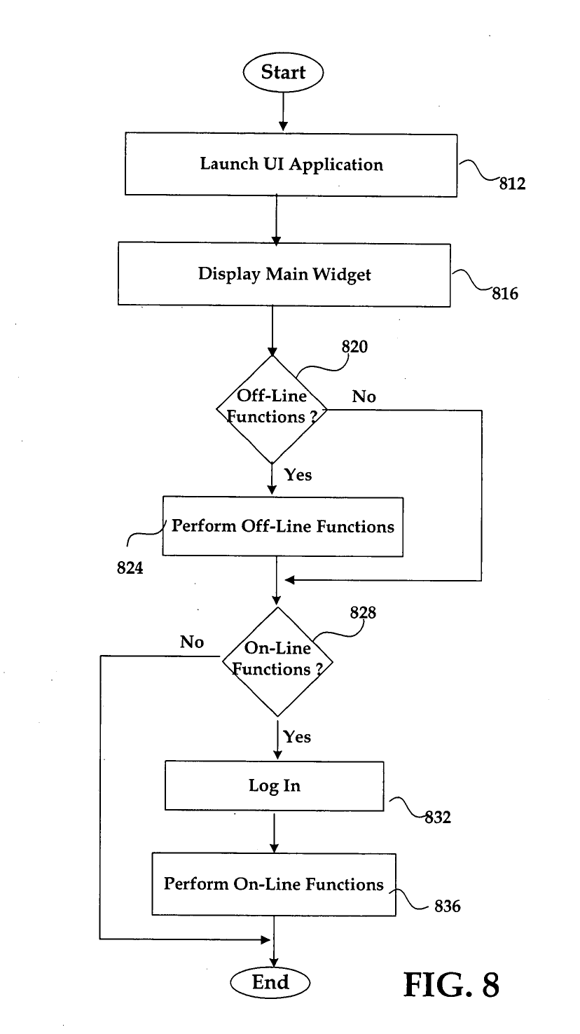

In the FIG. 4 embodiment, info tab 430 may be selected to create and transmit a request for profile information regarding any of the device users of either user device 112 or buddy device(s) 116 in electronic network 110. The foregoing request for profile information may include any desired types of information. For example, in the FIG. 4 embodiment, a request for profile information may selectively ask for information such as user nickname, user email address, user URL, user sex, user age, user birthday, user blood type, user country, user state, user hobby, user photo, and user description. The utilization of main widget 434 in performing network communications procedures is further discussed below in conjunction with FIG. 8.

Referring now to FIG. 5, a block diagram for one embodiment of a MEET widget 510 for a network communications procedure is shown, in accordance with one embodiment of the present invention. In the FIG. 5 embodiment, MEET widget 510 may be generated by UI application 320 to replace main widget 410 (FIG. 4) when MEET tab 418 is selected by a device user. In the FIG. 5 embodiment, MEET widget 510 may preferably include, but is not limited to, a presence tab 414, a MEET tab 418, a buddy tab 422, a content tab 426, an info tab 430, and a MEET window area 534. In alternate embodiments, MEET widget 510 may readily include various other elements or functionalities in addition to, or instead of, those elements or functionalities discussed in conjunction with the FIG. 5 embodiment.

In the FIG. 5 embodiment, MEET widget 510 may be selected to display a buddy 1 entry 516(a) through a buddy N entry 516(d) that each correspond to one of the buddy devices 116 or the user device 112 in electronic network 110. Each of the buddy entries 516 may include various types of buddy information corresponding to that respective buddy entry 516. For example, in the FIG. 5 embodiment, each of the buddy entries 516 from MEET window area 534 may include a buddy group name, an on-line/off-line status icon, a buddy screen name, and a buddy resource name.

In addition, buddy entries 516 may also each include a listing of any network services available from a given buddy device 116 or from user device 112 for performing various network service sharing procedures over electronic network 110. The foregoing network services may include shareable content information, as discussed above in conjunction with FIG. 4. In the FIG. 5 embodiment, the listings of available network services may include specific individual service names and corresponding service icons for each of the network services.

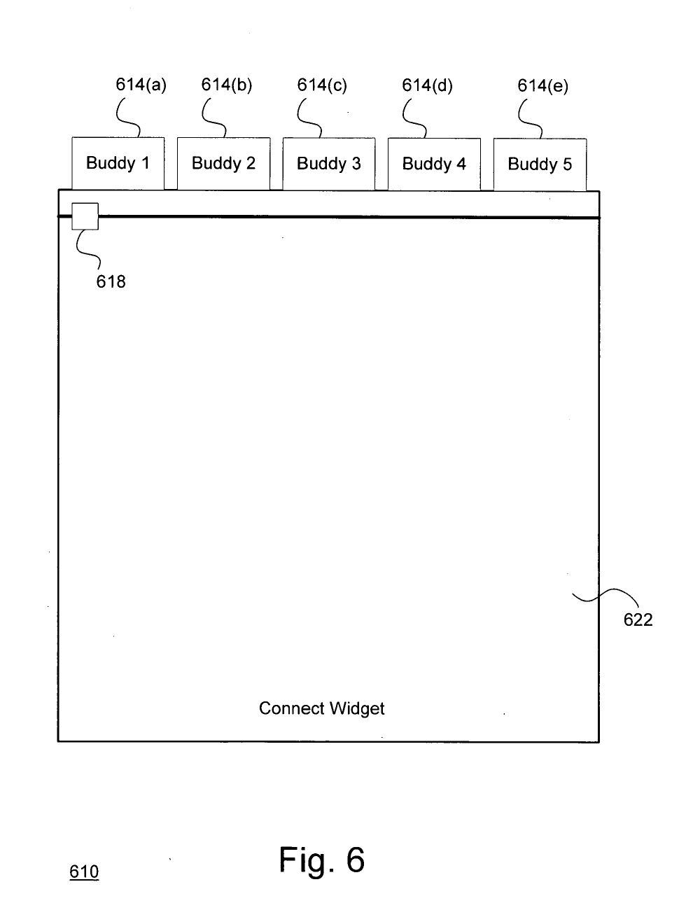

In the FIG. 5 embodiment, UI application 320 may generate a communications menu corresponding to any of the buddy entries 516 in MEET window area 534. A device user may then utilize the communications menu to initiate a network communications procedure over electronic network 110. The device user may utilize the communications menu to designate a particular buddy entry 416 with which to selectively enter either an instant messaging mode (such as a chat mode), a single message mode, or a content messaging mode. In certain embodiments, UI application 320 may then generate a content widget upon the screen of display 216 for performing the selected network communications procedure. One embodiment for the foregoing content widget is further discussed in conjunction with FIG. 6.

Referring now to FIG. 6, a block diagram of a connect widget 610 for a network communications procedure is shown, in accordance with one embodiment of the present invention. In the FIG. 6 embodiment, connect widget 610 may preferably include, but is not limited to, a series of buddy tabs 614, a buddy scrolling tab 618, and a connect display area 622. In alternate embodiments, connect widget 610 may readily include various other elements, configurations, or functionalities in addition to, or instead of, those elements, configurations, or functionalities discussed in conjunction with the FIG. 6 embodiment.

As discussed above in conjunction with the FIG. 5 embodiment, while viewing one or more buddy entries 516 after selecting MEET tab 418, UI application 320 may generate a communications menu corresponding to any of the buddy entries 516 in MEET window area 534 (FIG. 5). A device user may then utilize the communications menu to initiate a network communications procedure over electronic network 110. In the FIG. 6 embodiment, the device user may utilize the communications menu to designate a particular buddy entry 416 with which to selectively enter either an instant messaging mode (such as a chat mode), a single message mode, or a content messaging mode.

In the FIG. 6 embodiment, UI application 320 may responsively display connect widget 610 upon a portion of the screen of display 216 (FIG. 2) for use by a device user. For example, in certain embodiments, connect widget 610 may be displayed in the upper right quadrant of the screen of display 216. UI application 320 may then display various types of relevant information and widgets in the connect window area 622, corresponding to which of the buddy tabs 614 have been selected by the device user.

In the FIG. 6 embodiment, the foregoing instant messaging mode may be utilized to perform bi-directional communications between user device 112 and whichever buddy device 116 is selected with buddy tabs 614. For example, the instant messaging mode may support chat functionality with bi-directional text messaging. The single message mode may be utilized to send a single text message to a designated buddy device 116 without waiting for an answer. In the single message mode, connect widget 610 may be automatically closed as soon as the single message is transmitted. In the foregoing content messaging mode, connect window area 622 may be utilized to either share content information associated with a particular announced network service, or to view the shared content information while simultaneously conducting instant messaging, such as bi-directional chat, over electronic network 110.

In the FIG. 6 embodiment, for purposes of illustration, connect widget 610 is shown with five buddy tabs 614(a) through 614(e) that each correspond to a different buddy device 116. However, in alternate embodiments, any number of buddy devices 116 may be associated with connect widget 610 through buddy tabs 614. In the event that a greater number of buddy tabs 614 exist than are able to be concurrently displayed on connect widget 610, then the device user may advantageously utilize buddy scrolling tab 618 to scroll buddy tabs 614 to change the particular buddy tabs 614 that are displayed as part of connect widget 610. The device user may thus effectively utilize buddy scrolling tab 618 to reposition the displayed buddy tabs 614, and thereby gain access to a particular desired one of the buddy tabs 614 which may not have been initially displayed upon connect widget 610.

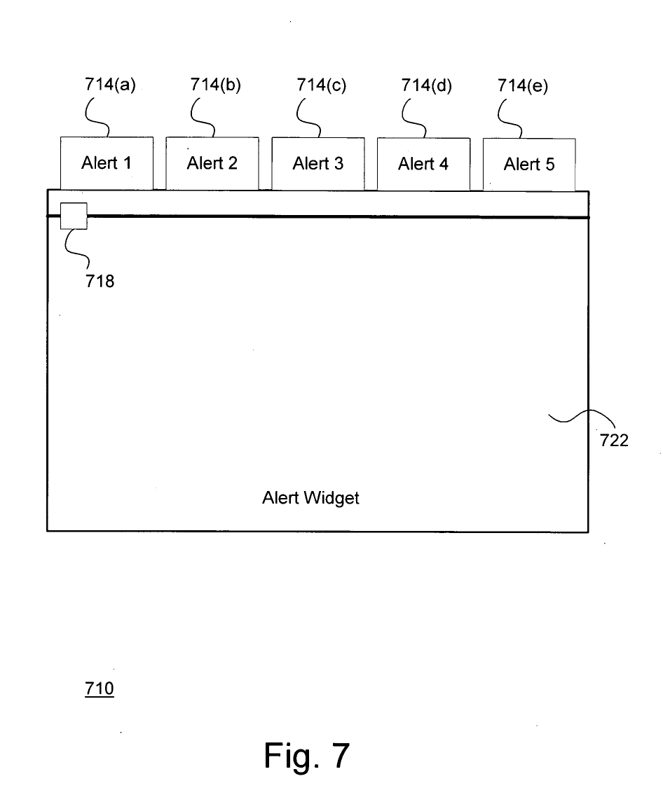

Referring now to FIG. 7, a block diagram of an alert widget 710 is shown, in accordance with one embodiment of the present invention. In the FIG. 7 embodiment, alert widget 710 may preferably include, but is not limited to, a series of alert tabs 714, an alert scrolling tab 718, and an alert display area 722. In alternate embodiments, alert widget 710 may readily include various other elements, configurations, or functionalities in addition to, or instead of, those elements, configurations, or functionalities discussed in conjunction with the FIG. 7 embodiment.

In certain situations, UI application 320 or another entity in electronic network 110 may need to make various types of status changes or other events visible to the device user. UI application 320 may therefore responsively display alert widget 710 upon a portion of the screen of display 216 (FIG. 2) for viewing of a corresponding alert message by the device user. For example, in certain embodiments, alert widget 622 may be displayed in the lower left quadrant of the screen of display 216. UI application 320 may then display various types of relevant information and alert messages in the alert window area 722, depending upon which of the alert tabs 714 has been selected by the device user.

In the FIG. 7 embodiment, alert widget 710 may function in either a notification mode or a decision mode. In the notification mode, no response may be required from the device user, other than potentially allowing the device user to acknowledge receipt of the alert message. However, in the decision mode, a decision may be required by the device user. For example, the device user may be required to approve/disapprove or to answer yes/no to a particular alert message.

In certain embodiments, events or conditions that may cause UI application 320 to dynamically display alert window 710 and provide a corresponding alert message may include, but are not limited to, various types of error messages for user device 112, network server 114, buddy devices 116, or electronic network 110, subscription requests for buddy list 324, invitations for sharing content information, receiving of single messages in the single message mode, or retrieving profile information.

In the FIG. 7 embodiment, for purposes of illustration, alert widget 710 is shown with five alert tabs 714(a) through 714(e) that each correspond to a different alert message. However, in alternate embodiments, any number of alert messages may be associated with alert widget 710 through alert tabs 714. In the event that a greater number of alert tabs 714 exist than are able to be concurrently displayed on alert widget 710, then the device user may advantageously utilize alert scrolling tab 718 to scroll alert tabs 714 to change the particular alert tabs 714 that are displayed as part of alert widget 710. The device user may thus effectively utilize alert scrolling tab 718 to reposition the displayed alert tabs 714, and thereby gain access to a particular desired one of the alert tabs 714 which may not have been initially displayed upon alert widget 710.

Referring now to FIG. 8, a flowchart of method steps for utilizing a dynamic user interface in an electronic network 110 is shown, in accordance with one embodiment of the present invention. The FIG. 8 example is presented for purposes of illustration, and in alternate embodiments, the present invention may readily utilize various other steps and sequences than those discussed in conjunction with the FIG. 8 embodiment.

In the FIG. 8 embodiment, in step 812, a user device 112 or other appropriate entity in electronic network 110 may initially launch a user interface (UI) application 312 to provide a dynamic user interface on display 216 of user device 112 for use by a device user in performing various network communications procedures. Then, in step 816, UI application 320 may responsively generate and display a main widget 410 on display 216 of user device 112. In the FIG. 8 embodiment, main widget 410 may include, but is not limited to, a presence tab 414, a MEET tab 418, a buddy tab 422, a content tab 426, an info tab 430, and a main window area 434 for selecting and displaying various types of network communications functionality and other related information.

In step 820, the device user may determine whether to utilize main widget 410 to initiate any off-line functions in an off-line mode. For example, in a content off-line mode, the content tab 426 may be selected for adding shareable content information, for editing shareable content information, or for removing shareable content information for sharing with various buddy devices 116 over electronic network 110.

In foregoing step 820 of the FIG. 8 embodiment, if the device user determines not to initiate any off-line functions, then the FIG. 8 process may advance to step 828. However, if the device user does decide to perform off-line functions, then in step 824, the device user may effectively utilize UI application 320 and user device 112 to perform those desired off-line functions.

In step 828, the device user may determine whether to utilize main widget 410 to initiate any on-line functions in an on-line mode. If the device user determines not to initiate any on-line functions, then the FIG. 8 process may terminate. In certain embodiments, the FIG. 8 process may alternately return to foregoing step 820 to perform additional off-line functions. However, if the device user does decide to perform on-line functions, then in step 832, in a presence off-line mode, the device user may select the presence tab 414 of main widget 410, and may then perform a log-in procedure for connecting user device 112 to electronic network 110 through a network server 114 to thereby perform various on-line functions in the on-line mode.

Finally, in step 836, the device user may effectively utilize UI application 320 and user device 112 to perform the desired on-line functions. For example, in certain embodiments, the device user may select presence tab 414 for changing various presence attributes of user device 112. The device user may also select a buddy tab 422 to add a new buddy device 116 from electronic network 110 to a buddy list 324, to remove a current buddy device 116 from buddy list 324, or to edit various types of buddy information for one or more of the buddy devices 116.

Furthermore, in the on-line mode, the device user may select content tab 426 for viewing a list of previously-defined shareable content information. The device user may then send one or more content sharing invitations to corresponding buddy devices 116 in electronic network 110 for potentially sharing the designated shareable content information. In addition, the device user may select the info tab 430 to create and transmit a request for profile information regarding any of the device users of buddy devices 116 in electronic network 110.

In the on-line mode, the device user may also select MEET tab 418 to display one or more buddy entries 516 that each correspond to one of the buddy devices 116 in electronic network 110. Each of the buddy entries 516 may include various types of buddy information corresponding to that respective buddy entry 516. UI application 320 may then generate a communications menu corresponding to any of the buddy entries 516 in MEET window area 534.

A device user may utilize the foregoing communications menu to initiate a network communications procedure over electronic network 110. For example, the device user may utilize the communications menu to designate a particular buddy entry 416 with which to selectively enter either an instant messaging mode (such as a chat mode), a single message mode, or a content messaging mode. In certain embodiments, UI application 320 may then dynamically generate a content widget 610 upon the screen of display 216 for performing the selected network communications procedure. At any point in the FIG. 8 process after UI application 320 is launched in foregoing step 812, UI application 320 may advantageously display a dynamic alert widget 710 upon a portion of display 216 for viewing a corresponding alert message by the device user.

In step 836 of the FIG. 8 embodiment, if the device user determines to perform no further on-line functions, then presence tab 414 may be selected for logging-out from electronic network 110 in a presence on-line mode, and the FIG. 8 process may terminate. In certain embodiments, the FIG. 8 process may alternately return to foregoing step 820 to perform additional off-line functions. The present invention therefore provides an improved dynamic user-interface for conducting network communications procedures in an electronic network by dynamically organizing and displaying appropriate information in an effective manner.

The invention has been explained above with reference to certain embodiments. Other embodiments will be apparent to those skilled in the art in light of this disclosure. For example, the present invention may readily be implemented using configurations and techniques other than those described in the embodiments above. Additionally, the present invention may effectively be used in conjunction with systems other than those described above. Therefore, these and other variations upon the discussed embodiments are intended to be covered by the present invention, which is limited only by the appended claims.

1. A system for implementing a user interface in an electronic device, comprising:
a user interface application configured to generate said user interface upon a display of said electronic device, said user interface application selectively generating a main widget, a connect widget, and an alert widget as parts of said user interface; and
a processor device coupled to said electronic device, said processor device being configured to control said user interface application for performing network communications procedures in an electronic network.

2. The system of claim 1 wherein said network communication procedures are performed between said electronic device and one or more buddy devices through a network server of said electronic network, said network communication procedures including instant messaging processes and sharing of content information for corresponding network services.

3. The system of claim 1 wherein said main widget includes a presence tab, a MEET tab, a buddy tab, a content tab, an info tab, and a main window area.

4. The system of claim 3 wherein a device user selects said presence tab in a presence off-line mode for logging-in to a network server to gain access to said electronic network.

5. The system of claim 3 wherein a device user selects said presence tab in a presence on-line mode for logging-out from a network server of said electronic network, said device user alternately selecting said presence tab in said presence on-line mode for changing presence attributes of said electronic device, said presence attributes including a visibility attribute and a status attribute for said electronic device.

6. The system of claim 3 wherein a device user selects said buddy tab to add a new buddy device to a buddy list of communication partners for said electronic device, said device user alternately selecting said buddy tab to remove a current buddy device from said buddy list, said device user also selecting said buddy tab to edit buddy information corresponding to one or more of said communication partners.

7. The system of claim 3 wherein a device user selects said content tab in a content off-line mode for adding shareable content information, for editing said shareable content information, and for removing said shareable content information, said shareable content information being stored in a memory device for sharing with one or more buddy devices over said electronic network.

8. The system of claim 3 wherein a device user selects said content tab in a content on-line mode for viewing a list of previously-defined shareable content information, said device user then sending content sharing invitations to one or more buddy devices for sharing said previously-defined shareable content information.

9. The system of claim 3 wherein a device user selects said info tab to create and transmit a request for profile information regarding one or more buddy devices in said electronic network.

10. The system of claim 9 wherein said request for said profile information requests a user nickname, a user email address, a user URL, a user sex, a user age, a user birthday, a user blood type, a user country, a user state, a user hobby, a user photo, and a user description.

11. The system of claim 3 wherein said device user selects said MEET tab to display a MEET widget that includes one or more buddy entries that include buddy information corresponding to one or more buddy devices in said electronic network.

12. The system of claim 11 wherein said buddy information includes a buddy group name, an on-line/off-line status icon, a buddy screen name, a buddy resource name, and a listing of network services available for performing network service sharing procedures over said electronic network.

13. The system of claim 11 wherein said device user utilizes said MEET widget to view a communications menu corresponding to a selected one of said one or more buddy entries, said device user then utilizing said communications menu to initiate said network communications procedures over said electronic network.

14. The system of claim 13 wherein said device user selects an instant messaging mode from said communications menu, said user interface application then dynamically displaying said connect widget upon a portion of said display, said device user utilizing said connect widget to conduct bi-directional chat-type communications between said electronic device and a selected one of said one or more buddy devices.

15. The system of claim 13 wherein said device user selects a single message mode from said communications menu, said user interface application then dynamically displaying said connect widget upon a portion of said display, said device user utilizing said connect widget to send a single message from said electronic device to a selected one of said one or more buddy devices.

16. The system of claim 13 wherein said device user selects a content messaging mode from said communications menu, said user interface application then dynamically displaying said connect widget upon a portion of said display, said device user utilizing said connect widget to either share content information associated with a particular announced network service, or to view said content information while simultaneously conducting instant messaging over said electronic network.

17. The system of claim 1 wherein said connect widget includes a series of buddy tabs for selecting which of said one or more buddy devices are designated for said network communications procedures, said connect widget further comprising a buddy scrolling tab for repositioning which of said buddy tabs are currently displayed on said connect widget if a greater number of said buddy tabs exist than may concurrently be displayed on said connect widget.

18. The system of claim 1 wherein said user interface application dynamically displays said alert widget upon a portion of said display for viewing corresponding alert messages relating to status changes or other events in at least one of said electronic device, one or more buddy devices, a network server device, and said electronic network.

19. The system of claim 18 wherein said alert widget functions in a notification mode in which no response is required from a device user, said alert widget alternately functioning in a decision mode in which a decision is required by said device user to approve or disapprove a particular one of said alert messages.

20. The system of claim 1 wherein said alert widget includes a series of alert tabs for selecting from among a plurality of alert messages, said alert widget further comprising an alert scrolling tab for repositioning which of said alert tabs are currently displayed on said alert widget if a greater number of said alert tabs exist than may concurrently be displayed on said alert widget.

21. A method for implementing a user interface in an electronic device, comprising the steps of:
generating said user interface upon a display of said electronic device by utilizing a user interface application that selectively generates a main widget, a connect widget, and an alert widget as parts of said user interface; and
controlling said user interface application with a processor device that is coupled to said electronic device for performing network communications procedures in an electronic network.

22. The method of claim 21 wherein said network communication procedures are performed between said electronic device and one or more buddy devices through a network server of said electronic network, said network communication procedures including instant messaging processes and sharing of content information for corresponding network services.

23. The method of claim 21 wherein said main widget includes a presence tab, a MEET tab, a buddy tab, a content tab, an info tab, and a main window area.

24. The method of claim 23 wherein a device user selects said presence tab in a presence off-line mode for logging-in to a network server to gain access to said electronic network.

25. The method of claim 23 wherein a device user selects said presence tab in a presence on-line mode for logging-out from a network server of said electronic network, said device user alternately selecting said presence tab in said presence on-line mode for changing presence attributes of said electronic device, said presence attributes including a visibility attribute and a status attribute for said electronic device.

26. The method of claim 23 wherein a device user selects said buddy tab to add a new buddy device to a buddy list of communication partners for said electronic device, said device user alternately selecting said buddy tab to remove a current buddy device from said buddy list, said device user also selecting said buddy tab to edit buddy information corresponding to one or more of said communication partners.

27. The method of claim 23 wherein a device user selects said content tab in a content off-line mode for adding shareable content information, for editing said shareable content information, and for removing said shareable content information, said shareable content information being stored in a memory device for sharing with one or more buddy devices over said electronic network.

28. The method of claim 23 wherein a device user selects said content tab in a content on-line mode for viewing a list of previously-defined shareable content information, said device user then sending content sharing invitations to one or more buddy devices for sharing said previously-defined shareable content information.

29. The method of claim 23 wherein a device user selects said info tab to create and transmit a request for profile information regarding one or more buddy devices in said electronic network.

30. The method of claim 29 wherein said request for said profile information requests a user nickname, a user email address, a user URL, a user sex, a user age, a user birthday, a user blood type, a user country, a user state, a user hobby, a user photo, and a user description.

31. The method of claim 23 wherein said device user selects said MEET tab to display a MEET widget that includes one or more buddy entries that include buddy information corresponding to one or more buddy devices in said electronic network.

32. The method of claim 31 wherein said buddy information includes a buddy group name, an on-line/off-line status icon, a buddy screen name, a buddy resource name, and a listing of network services available for performing network service sharing procedures over said electronic network.

33. The method of claim 31 wherein said device user utilizes said MEET widget to view a communications menu corresponding to a selected one of said one or more buddy entries, said device user then utilizing said communications menu to initiate said network communications procedures over said electronic network.

34. The method of claim 33 wherein said device user selects an instant messaging mode from said communications menu, said user interface application then dynamically displaying said connect widget upon a portion of said display, said device user utilizing said connect widget to conduct bi-directional chat-type communications between said electronic device and a selected one of said one or more buddy devices.

35. The method of claim 33 wherein said device user selects a single message mode from said communications menu, said user interface application then dynamically displaying said connect widget upon a portion of said display, said device user utilizing said connect widget to send a single message from said electronic device to a selected one of said one or more buddy devices.

36. The method of claim 33 wherein said device user selects a content messaging mode from said communications menu, said user interface application then dynamically displaying said connect widget upon a portion of said display, said device user utilizing said connect widget to either share content information associated with a particular announced network service, or to view said content information while simultaneously conducting instant messaging over said electronic network.

37. The method of claim 21 wherein said connect widget includes a series of buddy tabs for selecting which of said one or more buddy devices are designated for said network communications procedures, said connect widget further comprising a buddy scrolling tab for repositioning which of said buddy tabs are currently displayed on said connect widget if a greater number of said buddy tabs exist than may concurrently be displayed on said connect widget.

38. The method of claim 21 wherein said user interface application dynamically displays said alert widget upon a portion of said display for viewing corresponding alert messages relating to status changes or other events in at least one of said electronic device, one or more buddy devices, a network server device, and said electronic network.

39. The method of claim 38 wherein said alert widget functions in a notification mode in which no response is required from a device user, said alert widget alternately functioning in a decision mode in which a decision is required by said device user to approve or disapprove a particular one of said alert messages.

40. The method of claim 21 wherein said alert widget includes a series of alert tabs for selecting from among a plurality of alert messages, said alert widget further comprising an alert scrolling tab for repositioning which of said alert tabs are currently displayed on said alert widget if a greater number of said alert tabs exist than may concurrently be displayed on said alert widget.

41. A computer-readable medium comprising program instructions for implementing a user interface in an electronic device, by performing the steps of:
generating said user interface upon a display of said electronic device by utilizing a user interface application that selectively generates a main widget, a connect widget, and an alert widget as parts of said user interface; and
controlling said user interface application with a processor device that is coupled to said electronic device for performing network communications procedures in an electronic network.

42. A system for implementing a user interface in an electronic device, comprising:
means for generating said user interface upon a display of said electronic device, said means for generating selectively generating a main widget, a connect widget, and an alert widget as parts of said user interface; and
means for controlling said means for generating to perform network communications procedures in an electronic network.
